(19) United States
(12) Patent Application Publication
(10) Pub. No.: US 2013/0272438 A1
(43) Pub. Date: Oct. 17, 2013

(54) METHOD, TRANSMITTER AND RECEIVER FOR BEAMFORMING

(71) Applicants: Dalin Zhu, Beijing (CN); Yu Zhang, Beijing (CN); Gang Wang, Beijing (CN); Ming Lei, Beijing (CN)

(72) Inventors: Dalin Zhu, Beijing (CN); Yu Zhang, Beijing (CN); Gang Wang, Beijing (CN); Ming Lei, Beijing (CN)

(73) Assignee: NEC (CHINA) CO., LTD., Beijing (CN)

(21) Appl. No.: 13/879,592

(22) PCT Filed: Mar. 16, 2011
(86) PCT No.: PCT/CN2011/071843

§ 371 Date: Jun. 5, 2013

(51) Int. Cl. H04B 7/04

(52) U.S. Cl. CPC H04B 7/0478
USPC 375/267

(57) ABSTRACT

Embodiments of the invention provide a method for beamforming based on Grassmannian predictive coding (GPC) in a MIMO system. The method may comprise steps of: estimating present channel direction information (CDI) according to a received signal; predicting future CDI based on the present CDI and at least one of previous CDIs; predicting future codebook based on present codebook and at least one of previous codebooks; selecting a codeword from the future codebook based on the future CSI; and feeding back an index of the selected codeword to the transmitter.

### FIELD OF THE INVENTION

Embodiments of the present invention generally relate to wireless communications. More particularly, embodiments of the present invention relate to a method, transmitter and receiver for beamforming based on Grassmannian predictive coding (GPC) in a MIMO system.

### BACKGROUND OF THE INVENTION

A multiple-input multiple-output (MIMO) system is capable of supporting high throughput and highly reliable wireless transmissions through multiplexing gain and diversity gain, respectively. In MIMO systems, linear precoding based spatial multiplexing is a promising technique. As a special case of precoding, transmit beamforming (rank-1 precoding) provides full diversity gain for MIMO communications.

However, transmit beamforming requires the channel direction information (CDI) be available at the transmitter. Limited feedback is commonly used to convey the CDI to the transmitter.

At the receiver, by quantizing the estimated CDI using a fixed off-line designed codebook, only the index (in terms of a small number of bits) of the selected codeword is fed back to the transmitter. In most prior works, oneshot memoryless limited feedback strategy is performed by adopting the block fading channel model 1. However, in practice, due to the mobility in the propagation environment, the wireless channels usually exhibit memories, which can be characterized by the temporal correlations. In addition, due to the feedback delay, the quantized CDI may become outdated before its actual use at the transmitter. This feedback delay is brought by the channel-access protocols overhead and/or signal processing intervals, which may significantly degrade the system performance.

Numerous research efforts have been devoted to designing efficient feedback strategies for time-selective MIMO channels with memories. However, none of these efforts concentrates on accurately tracking the future channel state information (CSI) to compensate for the feedback delay. Grassmannian predictive coding (GPC) algorithm or transmit beamforming MIMO had been investigated in document “Predictive coding on the grassmannian manifold,” submitted to IEEE Trans. on Signal Process., August 2009 by T. Inoue and R. W. Heath. In this scheme, a manifold constrained prediction framework with optimized step size parameter is developed by exploiting the differential geometric properties of the Grassmannian manifold.

However, the existing GPC algorithm has following problems. First, as both the direction and the amplitude of the transported error tangent vector have to be separately quantized, the overall quantization resolution may not be ensured especially for a low feedback rate. Second, both the starting prediction vector and the correction vector have to be initialized in advance, and the initialization errors may cause the codeword representing the error tangent vector with possibly wrong base point.

### SUMMARY OF THE INVENTION

In view of the foregoing problems, there is a need in the art to provide methods and apparatuses for beamforming in the MIMO system with a higher CDI resolution.

In the invention, under the framework of GPC, a novel transmit beamforming scheme is presented for time-varying MIMO channels with delayed limited feedback. The invention consists of a two-stage optimization process at the receiver. The first-stage optimization is accomplished by quantization. Instead of quantizing the error tangent vector, the invention directly quantizes the estimated CDI and feeds it back to the transmitter. After the codeword selection, the second-stage optimization is performed by minimizing the mean squared error (MSE) between the predicted CDI and the observed CDI.

According to a first aspect of the present invention, embodiments of the invention provide a method for beamforming based on Grassmannian predictive coding (GPC) in a MIMO system. The method may comprise: estimating present channel direction information (CDI) according to a received signal; predicting future CDI based on the present CDI and at least one of previous CDIs; predicting future codebook based on present codebook and at least one of previous codebooks; selecting a codeword from the future codebook based on the future CSI; and feeding back an index of the selected codeword to the transmitter.

According to a second aspect of the present invention, embodiments of the invention provide a method for beamforming based on Grassmannian predictive coding (GPC) in a MIMO system. The method may comprise steps of: receiving an index of a selected codeword from a receiver; predicting future codebook based on present codebook and at least one of previous codebooks; selecting a codeword from the future codebook based on the index; and performing beamforming by using the selected codeword.

According to a third aspect of the present invention, embodiments of the invention provide an receiver for beamforming based on Grassmannian predictive coding (GPC) in a MIMO system. The receiver may comprise: an estimating device, configured to estimate present channel direction information (CDI) according to a received signal; a CDI predicting device, configured to predict future CDI based on the present CDI and at least one of previous CDIs; a codebook predicting device, configured to predict future codebook based on present codebook and at least one of previous codebooks; a selecting device, configured to select a codeword from the future codebook based on the future CSI; and a feedback device, configured to feed back an index of the selected codeword to the transmitter.

According to a fourth aspect of the present invention, embodiments of the invention provide a transmitter for beamforming based on Grassmannian predictive coding (GPC) in a MIMO system. The transmitter may comprise: receiving device, configured to receive an index of a selected codeword from a receiver; predicting device, configured to predict future codebook based on present codebook and at least one of previous codebooks; selecting device, configured to select a codeword from the future codebook based on the index; and beamforming device, configured to perform beamforming by using the selected codeword.

The following benefits can be expected with the invention.

Under the same amount of feedback bits, this invention shows significant throughput and error rate performance improvements in contrast to the existing prediction techniques.

By beamforming according to the invention, higher CDI resolution can be obtained.

There is no need to perform initialization in advance so that the beamforming process is simplified.

Other features and advantages of the embodiments of the present invention will also be apparent from the following description of specific embodiments when read in conjunction with the accompanying drawings, which illustrate, by way of example, the principles of embodiments of the invention.

### BRIEF DESCRIPTION OF THE DRAWINGS

Embodiments of the invention are presented in the sense of examples and their advantages are explained in greater detail below, with reference to the accompanying drawings, where

FIG. 1 illustrates a flow chart of a method for beamforming based on GPC in a MIMO system according to an embodiment of the invention;

FIG. 2 illustrates a flow chart of a method for beamforming based on GPC in a MIMO system according to another embodiment of the invention;

FIG. 3 illustrates a flow chart of a method for beamforming based on GPC in a MIMO system according to another embodiment of the invention; and

FIG. 4 illustrates block diagrams of a receiver and a transmitter in a MIMO system according to an embodiment of the invention.

### DETAILED DESCRIPTION OF EMBODIMENTS

Various embodiments of the present invention are described in detail with reference to the drawings. The flowcharts and block diagrams in the figures illustrate the apparatus, method, as well as architecture, functions and operations executable by a computer program product according to the embodiments of the present invention. In this regard, each block in the flowcharts or block may represent a module, a program, or a part of code, which contains one or more executable instructions for performing specified logic functions. It should be noted that in some alternatives, functions indicated in blocks may occur in an order differing from the order as illustrated in the figures. For example, two blocks illustrated consecutively may be actually performed in parallel substantially or in an inverse order, which depends on related functions. It should also be noted that block diagrams and/or each block in the flowcharts and a combination of thereof may be implemented by a dedicated hardware-based system for performing specified functions/operations or by a combination of dedicated hardware and computer instructions.

In below, terms used in the invention are explained for clarity purpose.

1. Present Channel Direction Information (CDI)

Transmit beamforming is a special case of precoding (i.e., rank-1 precoding). It provides full diversity gain for MIMO transmissions. Transmit beamforming requires that the channel direction information (CDI) be available at the transmitter.

Assuming the present instant is k, the present CDI is an estimation of the Channel state based on a received signal (for example, a reference signal) at the k instant. The estimation can be performed by a receiver in the MIMO system.

2. Previous CDI

In the embodiments of the invention, a previous CDI is a CDI which is actually used in the transmissions at a previous instant. For example, is the present instant is k, the CDIs at (k−1)^{th}, (k−2)^{th}, . . . , (k−k+1)^{th} instants are all previous CDIs. Any one of these previous CDIs can be referred to as a Previous CDI.

3. Future CDI

In the embodiments of the invention, a future CDI is predicted based on the present CDI and at least one of previous CDIs. The prediction can be performed by a receiver in the MIMO system. The future CDI is expected to be used by a transmitter in the beamforming at the next instant, for example, the (k+1)^{th} instant.

4. Present Codebook, Future Codebook, and Previous Codebook

A codebook can be predicted based on one or more previous codebooks.

A future codebook can be predicted at the k^{th} instant based on a present codebook and at lease one of previous codebooks. A present codebook can be predicted at the (k−1)^{th} instant in a similar way as the prediction process of the future codebook. And, a previous codebook can be predicted based on some earlier codebooks.

5. Error Metric

The term “error metric” is generally used to define the likelihood between two subspaces. For example, an error metric between two vectors may be the chordal distance, the Fubini-Study distance, the projection-two norm, the Euclidean metric, and so on, between two vectors.

If there are two sets of vectors and the number of vectors in each set is N, the error metric between a pair of vectors, each belonging to a respective set, may be defined as above. The error metric between the two sets could be a function of the error metrics of N pairs of vectors. For example, the error metric between the two sets may be average of the error metrics of N pairs of vectors, maximum of the error metrics of N pairs of vectors, mean square of the error metrics of N pairs of vectors, and so on.

Note that, in the invention, the term “present transmission” refers to the transmission at the present instant; the term “next transmission” refers to the transmission at the next instant after the present instant; and the term “previous transmissions” refers to the transmissions at the previous instants before the present instant.

The embodiments of the invention propose a novel transmit beamforming scheme under the framework of GPC. The scheme consists of a two-stage optimization process at the receiver. The first-stage optimization is accomplished by quantization. Instead of separately quantizing the direction and the amplitude of the error tangent vector, the invention directly quantizes the future CDI as a selected codeword and feeds it back to the transmitter. Moreover, different from the conventional quantization criterion used for block fading channel model, the codeword selection in the proposed scheme takes the optimized prediction into account. The second-stage optimization is performed by minimizing the error metric between the future CDI and the selected codeword from a future codebook. Optimized step size parameter along the geodesic direction is calculated at this stage and infrequently fed back to the transmitter. By combining the selected codeword with the optimized step size parameter, the future CDI can be accurately predicted at the transmitter.

An embodiment of the present invention discloses a method for beamforming based on GPC in a MIMO system. The method may comprise steps of: estimating present CDI according to a received signal; predicting future CDI based on the present CDI and at least one of previous CDIs; predicting future codebook based on present codebook and at least one of previous codebooks; selecting a codeword from the future codebook based on the future CSI; and feeding back an index of the selected codeword to the transmitter. This method can be performed by a receiver in a MIMO system.

An embodiment of the present invention discloses a method for beamforming based on GPC in a MIMO system. The method may comprise steps of: receiving an index of a selected codeword from a receiver; predicting future codebook based on present codebook and at least one of previous codebooks; selecting a codeword from the future codebook based on the index; and performing beamforming by using the selected codeword. This method can be performed by a transmitter in a MIMO system.

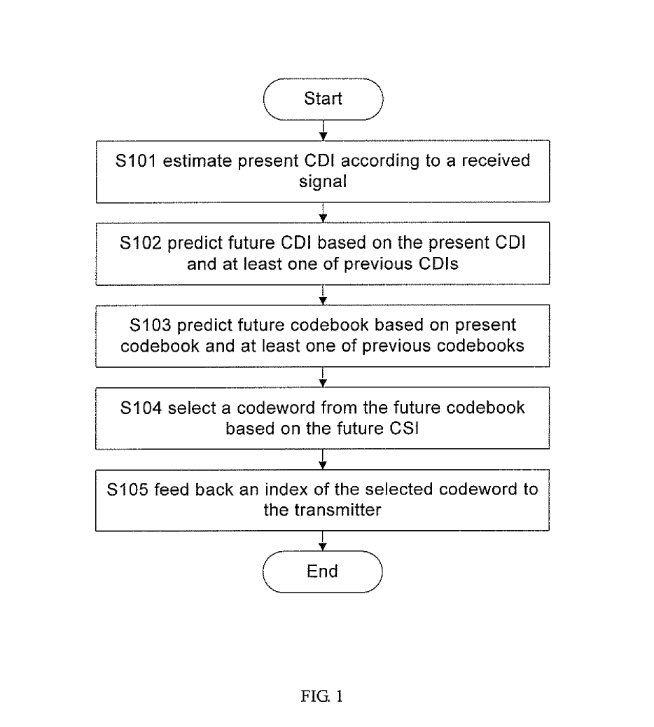

FIG. 1 illustrates a flow chart of a method for beamforming based on GPC in a MIMO system according to an embodiment of the invention.

At step S101, present CDI is estimated according to a received signal.

In an embodiment of the invention, the MIMO system is an FDD system. The present CDI may be estimated by a receiver based on a received signal sent from a transmitter at the present instant.

In the MIMO system, a transmitter transmits signals via a communication channel after beamforming. A receiver may obtain a channel matrix by utilizing the pilot sequence, reference signal or training sequence in the received signal(s) from the communication channel, so as to estimate the present CDI. There may be several estimation methods, for example, Minimum Mean Squared Error (MMSE) estimation, Least squares (LS) estimation, Recursive least squares (RLS) estimation, and so on.

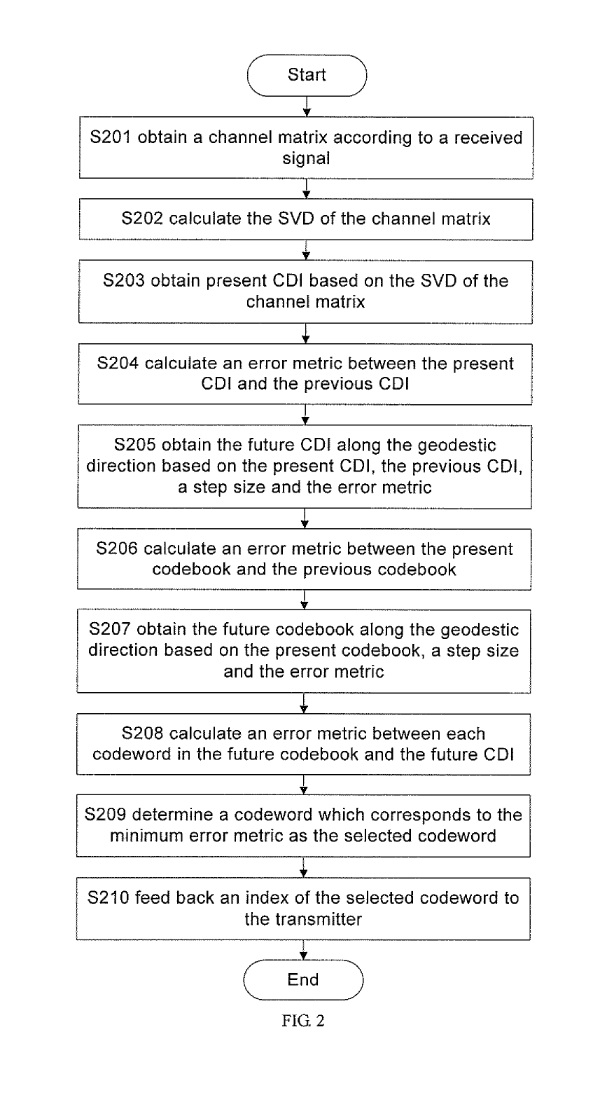

In an embodiment of the invention, the present CDI can be estimated by obtaining a channel matrix according to a received signal, calculating the singular value decomposition (SVD) of the channel matrix, and obtaining present CDI based on the SVD of the channel matrix. It will be explained in detail in the embodiment of FIG. 2.

In an embodiment of the invention, assuming the k^{th} instant as the present instant. The receiver may save in a memory the estimated present CDI which corresponds to the k^{th} instant. Prior to the k^{th} instant, the CDIs which correspond to the previous instants may be saved in the memory.

As can be appreciated by a skilled in the art, the memory may be a portable computer magnetic disk, hard disk, random access memory (RAM), read-only memory (ROM), erasable programmable read-only memory (EPROM or flash), optical fiber, portable compact disk read-only memory (CD-ROM), optical storage device, or a magnetic storage device.

As can be appreciated by a skilled in the art, although embodiments of the present invention provide limited examples for obtaining a present CDI based on the present transmission, many other suitable means known in the art may be adopted to implement step S101.

At step S102, future CDI is predicted based on the present CDI and at least one of previous CDIs.

In an embodiment of the invention, future CDI may be predicted by calculating an error metric between the present CDI and the previous CDI, and obtaining the future CDI along the geodestic direction based on the present CDI, the previous CDI, a step size and the error metric.

The step size may be optimized by several ways. For example, a set of step sizes can be defined firstly; then the error metric between the future CDI and the average of previous CDIs can be calculated by using each of the set of step sizes; and a step size corresponding to the minimum error metric may be determined as an optimized step size to be used in the calculation of the future CDI.

The average of previous CDIs may be calculated by averaging the CDIs obtained at all of the (k−1)^{th}, (k−2)^{th} . . . , and 1^{st} instants. The average of previous CDIs may be calculated by averaging the CDIs corresponding to one or more of the (k−1)^{th}, (k−2)^{th} . . . , and 1^{st} instants.

At step S103, future codebook is predicted based on present codebook and at least one of previous codebooks.

In an embodiment of the invention, the future codebook may be predicted by calculating an error metric between the present codebook and the previous codebook and obtaining the future codebook along the geodestic direction based on the present codebook, the previous CDI, a step size and the error metric.

The step size may be optimized by several ways. For example, a set of step sizes can be defined firstly; then the error metric between the future codebook and the average of previous codebooks can be calculated by using each of the set of step sizes; and a step size corresponding to the minimum error metric may be determined as an optimized step size to be used in the calculation of the future codebook.

The average of previous codebooks may be calculated by averaging the codebooks obtained at all of the (k−1)^{th}, (k−2)^{th} . . . , and 1^{st} instants. The average of previous codebooks may be calculated by averaging the codebooks corresponding to one or more of the (k−1)^{th}, (k−2)^{th} . . . , and 1^{st} instants.

At step S104, a codeword is selected from the future codebook based on the future CSI.

The codeword may be selected in several ways. In an embodiment of the invention, by calculating an error metric between each codeword in the future codebook and the future CDI, a codeword which corresponds to the minimum error metric may be determined as the selected codeword.

At step S105, an index of the selected codeword is fed back to the transmitter.

In this step, the index of the selected codeword may be determined from the future codebook, and the index may be quantized into limited bit(s) and fed back to the transmitter in a feedback channel with high efficiency.

Then, the flow of the embodiment of FIG. 1 ends up.

As can be appreciated by a skilled in the art, many other suitable means known in the art may be adopted and the method illustrated herein is only shown as an example rather than limitation.

FIG. 2 illustrates a flow chart of a method for beamforming based on GPC in a MIMO system according to another embodiment of the invention. The embodiment in FIG. 2 illustrates a more specific implementation than that in FIG. 1. In this embodiment, it is started by briefly reviewing the conventional one-shot memoryless feedback strategy for block fading MIMO channel. Assuming that the number of antenna at the transmitter side is Mₜ and the number of antenna at the receiver side is Mᵣ. At instant k, the channel matrix H[k] is assumed to be a Mᵣ×Mₜ, block matrix with each entry distributed according to CN(0, 1), where CN(0, 1) means complex Normal distribution with mean 0 variance 1.

At step S201, a channel matrix is obtained according to a received signal.

Steps S201-S203 can be used to substitute step S101 in FIG. 1. Specifically, after steps S201-S203, a receiver may obtain the channel matrix based on a received signal.

There are several ways to obtain a channel matrix from a received signal. For example, a reference signal can be sent from a transmitter and the reference signal can be processed at the receiver to obtain the channel matrix. As can be appreciated by a skilled in the art, although embodiments of the present invention provide limited examples for obtaining a channel matrix according to a received signal, many other suitable means known in the art may be adopted to implement step S201.

At step S202, the SVD of the channel matrix is calculated.

The SVD of H[k] may be calculated as

H[k]=V[k]Σ[k]U^{H}[k], (1)

where ( )^{H} denotes the conjugate transpose. In equation (1), V[k] is a Mᵣ×Mᵣ matrix, U[k] is a Mₜ×Mₜ matrix, and Σ[k] is a Mᵣ×Mₜ diagonal matrix with the diagonal entries sorted in a descending order.

At step S203, present CDI is obtained based on the SVD of the channel matrix.

In the embodiment, the present CDI is illustrated as a beamforming vector u[k], which can be obtained as the first column of matrix U[k]. Matrix U[k] is the right singular matrix of the SVD of the channel matrix H[k], as is shown in equation (1).

At step S204, an error metric between the present CDI and the previous CDI is calculated.

In the calculation of the error metric between the present CDI and the previous CDI, the previous CDI may be one or more CDI prior to the present CDI.

In an embodiment of the invention, assuming that the present instant is k and the previous CDI corresponds to the (k−1)^{th} instant. The error metric between the present CDI and the previous CDI can be calculated by computing a chordal distance, Fubini-Study distance, projection-two norm, and so on, between the present CDI and the previous CDI.

In other embodiments of the invention, assuming that the present instant is k and the previous CDIs corresponds to one or more of the (k−1)^{th}, (k−2)^{th} . . . , and 1^{st} instants. For example, the previous CDIs may include CDIs respectively corresponding to the (k−1)^{th} instant and the (k−2)^{th} instant; or, the previous CDIs may include CDIs respectively corresponding to the (k−1)^{th} instant, the (k−m)^{th} instant and the (k−n)^{th} instant, where m and n are integers small than k; or the previous CDIs may include CDIs respectively corresponding to the 1^{th} instant and the 3^{rd} instant. In this case, the error metric between the present CDI and the previous CDI may be calculated by computing a chordal distance, Fubini-Study distance, projection-two norm, and so on, between the present CDI and each of the previous CDI; and obtaining the average, maximum, or mean square of the error metrics.

For example, by exploring the smooth structure of the Grassmannian manifold, the error metric may be calculated as a chordal distance between the present CDI, denoted as u[k], and a previous CDI, denoted as u[k−1], given as:

d=\sqrt{1−|ρ|¹²}, (2)

where ρ=u^{H}[k−1]u[k]. In addition, the concept of parallel transport is defined by using the fact that the Grassmannian manifold has Riemannian geometry that a manifold is connected with respect to the Riemannian metric.

At step S205, the future CDI is obtained along the geodestic direction based on the present CDI, the previous CDI, a step size and the error metric.

In an embodiment of the invention, the concept of parallel transport may be defined by using the fact that the Grassmannian manifold has Riemannian geometry that a manifold is connected with respect to the Riemannian metric. The corresponding transported tangent vector e[k] can be therefore calculated as

$$e [ k ] = {tan}^{- 1} ( \frac{d}{\vert ρ \vert} ) \frac{u [ k ] {ρ}^{*} - u [ k - 1 ]}{d} \qquad ( 3 )$$

where (·)* denotes the conjugation, and the tangent vector ê[k] emanates from the present CDI u[k]. In equation (3), the present CDI u[k] the previous CDI u[k−1], and the error metric therebetween are used.

By using the geodestic properties of the Grassmannian manifold, the future CDI along the geodestic direction from u[k−1] to u[k] can be obtained as

$$\tilde{u} [ k + 1 ] = u [ k ] cos ( ‖ \hat{e} [ k ] ‖ {t}_{opt} ) + \frac{\hat{e} [ k ]}{‖ \hat{e} [ k ] ‖} sin ( ‖ \hat{e} [ k ] ‖ {t}_{opt} ) , \qquad ( 4 )$$

Where tₒₚₜ is the optimized step size parameter. The step size tₒₚₜ may be optimized by several ways. For example, tₒₚₜ can be firstly defined as any one of a set of predefined step sizes; then the error metric between the future CDI ũ[k+1] and the average of previous CDIs can be calculated by using each of the set of step sizes; and a step size corresponding to the minimum error metric may be determined as an optimized step size to be used in the calculation of the future CDI. The average of previous CDIs may be calculated by averaging the CDIs corresponding to all of the (k−1)^{th}, (k−2)^{th} . . . , and 1^{st} instants. The average of previous CDIs may be calculated by averaging the CDIs corresponding to one or more of the (k−1)^{th}, (k−2)^{th} . . . , and 1^{st} instants.

In another example, the optimized step size can be obtained by minimizing the MSE between the future CDI ũ[k+1] and the observed CDI u[k+1].

At step S206, an error metric between the present codebook and the previous codebook is calculated.

In an embodiment of the invention, there is a fixed off-line designed beamforming codebook W (referred as “initial codebook”) stored at both the transmitter and the receiver. More specifically, the initial codebook may be defined as W={w₁, w₂, . . . , w_{L}}, where wᵢεU^{M}^{ₜ}^{×1}, i=1, 2, . . . L, L is the total number of codewords and wᵢ is a Mₜ×1 normalized complex vector.

In the embodiment, the present codebook at instant k is defined as Wₖ and the previous codebook at instant k−1 is defined as Wₖ. w[k] is defined as the codeword that is selected from the codebook at instant k and its index in the future codebook is to be fed back to the transmitter for reconstruction. w[k−1] is defined as the codeword that is selected from the codebook at instant k−1. The error metric between the present codebook and the previous codebook can be defined as \tilde{d}ᵢ=\sqrt{1−|\tilde{ρ}|²}, where i=1, 2, . . . L, and \tilde{ρ} can be defined as w^{H}[k−1]w[k].

At instant k, for a given codeword wᵢ, the transported tangent vector \tilde{e}ᵢ that emanates from wᵢ can be calculated by using

$${\tilde{e}}_{i} = {tan}^{- 1} ( \frac{{\tilde{d}}_{i}}{{\tilde{ρ}}_{i}} ) \frac{{w}_{i} {\tilde{ρ}}_{i}^{*} - w [ k - 1 ]}{{\tilde{d}}_{i}} . \qquad ( 5 )$$

At step S207, the future codebook is obtained along the geodestic direction based on the present codebook, the previous CDI, a step size and the error metric.

The predicted codeword at instant k along the geodesic direction from w[k−1] to wᵢ can be computed as

$${\tilde{w}}_{i} = {w}_{i} cos ( ‖ {\tilde{e}}_{i} ‖ {\tilde{t}}_{i} ) + \frac{{\tilde{e}}_{i}}{‖ {\tilde{e}}_{i} ‖} sin ( ‖ {\tilde{e}}_{i} ‖ {\tilde{t}}_{i} ) , \qquad ( 6 )$$

where \tilde{t}ᵢ is an optimized step size. In an example, tᵢ may be initialized as tₒₚₜ; while for the rest of the algorithm, \tilde{t}ᵢ may be configured as the step size parameter optimized by several ways. For example, a set of step sizes can be defined firstly; then the error metric between the future codebook and the average of previous codebooks can be calculated by using each of the set of step sizes; and a step size corresponding to the minimum error metric may be determined as an optimized step size to be used in the calculation of the future codebook.

In an embodiment of the invention, an effective quantization criterion can be set up. Under the framework of GPC, the future CDI ũ[k+1] can be predicted by using equation (4). Therefore, for a given future CDI ũ[k+1], the quantization criterion may be maximizing |ũ^{H}[k+1]\tilde{w}ᵢ|² for i=1, 2, . . . , L, given by

$${w [ k ] = arg { max \vert {\tilde{u}}^{H} [ k +}_{{w}_{i} ∈ W , i = 1 , 2 , … , L} 1 ] {\tilde{w}}_{i} \vert}^{2} . \qquad ( 7 )$$

The future codebook Ŵₖ₊₁ along the geodesic direction can be can be calculated from the previous codebook Wₖ₋₁ and the present codebook Wₖ. The future codebook Ŵₖ₊₁. For example, the codeword selected from the future codebook is denoted as follows:

$$\begin{matrix}\hat{w} [ k + 1 ] = w [ k ] cos ( ‖ \tilde{e} [ k ] ‖ t ) + \frac{\tilde{e} [ k ]}{‖ \tilde{e} [ k ] ‖} sin ( ‖ \tilde{e} [ k ] ‖ \tilde{t} ) . \\ Here , & ( 8 ) \\ \tilde{e} [ k ] = {tan}^{- 1} ( \frac{\tilde{d} [ k ]}{\ddot{ρ} [ k ]} ) \frac{w [ k ] {\tilde{ρ}}^{*} [ k ] - w [ k - 1 ]}{\tilde{d} [ k ]} , & ( 9 )\end{matrix}$$

where \tilde{ρ}[k]=w_{H}[k−1]w[k]=\sqrt{1−|\tilde{ρ}[k]|²}, and \tilde{t} is the step size.

The step size t may be optimized by several ways. For example, a set of step sizes can be defined firstly; then the error metric between the future codebook and the average of previous codebooks can be calculated by using each of the set of step sizes; and a step size corresponding to the minimum error metric may be determined as an optimized step size to be used in the calculation of the future codebook.

In an embodiment of the invention, the optimization can be performed by minimizing the MSE between the future codebook ŵ[k+1] and the future CDI u[k+1], given as

$${\tilde{t}}_{opt} = arg max {E [ \vert {{u}^{H} [ k +}_{\tilde{t} ∈ [ 0.1 ]} 1 ] w [ k + 1 ] \vert}^{2} ] . \qquad ( 10 )$$

Closed-form expression of \tilde{t}ₒₚₜ is intractable and numerical search is performed.

At step S208, an error metric between each codeword in the future codebook and the future CDI is calculated.

The future codebook obtained from step S207 is a codebook with the same size as the initial codebook. Thus, The future codebook may be defined as wₖ₊₁={w_{k+1,1}, w_{k+1,2}, . . . , w_{k+1,L}}, where w_{k+1,i}εU^{M}^{ₜ}^{×1}, i=1, 2, . . . L, L is the total number of codewords and w_{k+1,i} is an Mₜ×1 normalized complex vector.

The future CDI obtained from step S205 is an Mₜ×1 normalized complex vector. Therefore, the error metric between each codeword in the future codebook w_{k+1,i} and the future CDI can be calculated. For example, the chordal distance, the Fubini-Study distance, the projection-two norm, and the Euclidean metric between each codeword in the future codebook w_{k+1,i} and the future CDI can be obtained.

At step S209, a codeword which corresponds to the minimum error metric is determined as the selected codeword.

After the calculation of step S208, Mₜ error metrics can be obtained. By sorting these Mₜ error metrics, the minimum one can be found easily. As can be appreciated by those skilled in the art, there are many ways to implement step S209 and the example here is only for illustration not limitation.

At step S210, an index of the selected codeword is fed back to the transmitter.

In this step, the index of the selected codeword may be determined from the future codebook, and the index may be quantized into limited bit(s) and fed back to the transmitter in a feedback channel with high efficiency.

As can be appreciated by those skilled in the art, step S210 can be implemented in different ways, which are omitted here for the purpose of brief.

Then, the flow of FIG. 2 ends up.

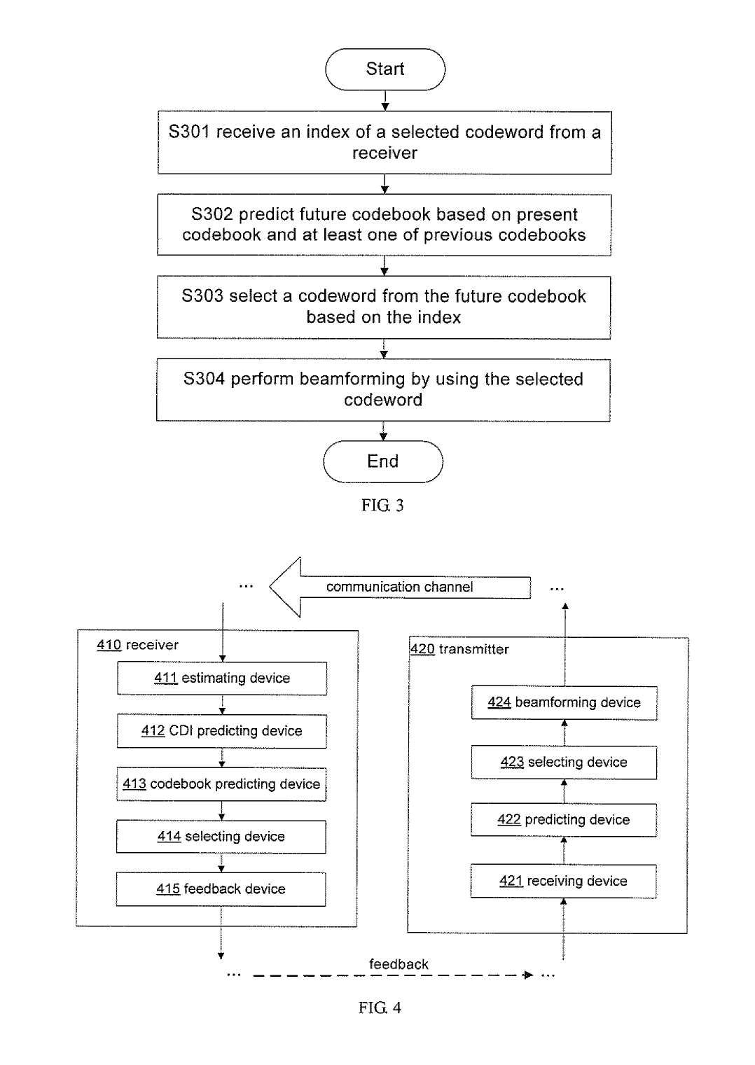

FIG. 3 illustrates a flow chart of a method for beamforming based on GPC in a MIMO system according to another embodiment of the invention.

At step S301, an index of a selected codeword is received from a receiver.

At step S302, future codebook is predicted based on present codebook and at least one of previous codebooks.

The future codebook can be predicted at step S302 in a similar way as at step S103. In an embodiment of the invention, the future codebook may be predicted by calculating an error metric between the present codebook and the previous codebook; and obtaining the future codebook along the geodestic direction based on the present codebook, the previous CDI, a step size and the error metric.

The step size may be optimized in several ways. For example, a set of step sizes can be defined firstly; then the error metric between the future codebook and the average of previous codebooks can be calculated by using each of the set of step sizes; and a step size corresponding to the minimum error metric may be determined as an optimized step size to be used in the calculation of the future codebook.

The average of previous codebooks may be calculated by averaging the codebooks obtained at all of instant k−1, instant k−2, . . . , and instant 1. The average of previous codebooks may be calculated by averaging the codebooks corresponding to one or more of instant k−1, instant k−2, . . . , and instant 1.

At step S303, a codeword is selected from the future codebook based on the index.

As is described, at the receiver, a codeword can be selected from the future codebook based on the future CSI (see step S104). Then, an index of the selected codeword can be fed back to the transmitter (see step S105), wherein the index of the selected codeword may be determined from the future codebook, in an embodiment, the selected codeword is for example the eighth in the further codebook, and the index (for example, 8) may be quantized into limited bit(s) and fed back to the transmitter.

In the embodiment, at step S303, a codeword, for example, the eighth codeword, can be selected from the future codebook based on the index 8.

At step S304, beamforming is performed by using the selected codeword.

Then, the flow of FIG. 3 ends up.

FIG. 4 illustrates block diagrams of a receiver 410 and a transmitter 420 in a MIMO system according to an embodiment of the invention.

The receiver 410 may comprise: an estimating device 411, a CDI predicting device 412, a codebook predicting device 413, a selecting device 414 and a feedback device 415.

The estimating device 411 can be configured to estimate present channel direction information (CDI) according to a received signal.

In an embodiment of the invention, the estimating device 411 may comprise: means for obtaining a channel matrix according to a received signal; means for calculating the singular value decomposition (SVD) of the channel matrix; and means for obtaining present CDI based on the SVD of the channel matrix.

The CDI predicting device 412 can be configured to predict future CDI based on the present CDI and at least one of previous CDIs.

In an embodiment of the invention, the CDI predicting device 412 may comprise: means for calculating an error metric between the present CDI and the previous CDI; and means for obtaining the future CDI along the geodestic direction based on the present CDI, the previous CDI, a step size and the error metric.

In an embodiment of the invention, the CDI predicting device 412 may further comprises: means for defining a set of step sizes; means for calculating the error metric between the future CDI and the average of previous CDIs by using each of the set of step sizes; and means for determining a step size corresponding to the minimum error metric.

The codebook predicting device 413 can be configured to predict future codebook based on present codebook and at least one of previous codebooks.

In an embodiment of the invention, the codebook predicting device 413 may comprise: means for calculating an error metric between the present codebook and the previous codebook; and means for obtaining the future codebook along the geodestic direction based on the present codebook, the previous CDI, a step size and the error metric.

In an embodiment of the invention, the codebook predicting device 413 may further comprise: means for defining a set of step sizes; means for calculating the error metric between the future codebook and the average of previous codebooks by using each of the set of step sizes; and means for determining a step size corresponding to the minimum error metric.

The selecting device 414 can be configured to select a codeword from the future codebook based on the future CSI.

In an embodiment of the invention, the selecting device 414 may comprise: means for calculating an error metric between each codeword in the future codebook and the future CDI; and means for determining a codeword which corresponds to the minimum error metric as the selected codeword.

The feedback device 415 can be configured to feed back an index of the selected codeword to the transmitter.

In an embodiment of the invention, the error metric can be one of the chordal distance, the Fubini-Study distance, the projection-two norm, and the Euclidean metric.

The transmitter 420 may comprises: a receiving device 421, a predicting device 422, a selecting device 423, and a beamforming device 424.

The receiving device 421 may be configured to receive an index of a selected codeword from a receiver.

The predicting device 422 may be configured to predict future codebook based on present codebook and at least one of previous codebooks.

In an embodiment of the invention, the predicting device 422 may comprise: means for calculating an error metric between the present codebook and the previous codebook; and means for obtaining the future codebook along the geodestic direction based on the present codebook, the previous CDI, a step size and the error metric.

In an embodiment of the invention, the predicting device 422 may further comprise: means for defining a set of step sizes; means for calculating the error metric between the future codebook and the average of previous codebooks by using each of the set of step sizes; and means for determining a step size corresponding to the minimum error metric.

The selecting device 423 may be configured to select a codeword from the future codebook based on the index.

The beamforming device 424 may be configured to perform beamforming by using the selected codeword.

In the MIMO system shown in FIG. 4, the receiver 410 may estimate present CDI according to a received signal; predict future CDI based on the present CDI and at least one of previous CDIs; predict future codebook based on present codebook and at least one of previous codebooks; select a codeword from the future codebook based on the future CSI; and feed back, via a feedback channel, an index of the selected codeword to the transmitter 420. The transmitter 420 may receive the index of a selected codeword from a receiver; predict future codebook based on present codebook and at least one of previous codebooks; select a codeword from the future codebook based on the index; and perform beamforming, via the communication channel, by using the selected codeword.

Embodiments of the present invention may also be implemented as a computer program product, comprising at least one computer readable storage medium having a computer readable program code portion stored thereon. In such embodiments, the computer readable program code portion comprises at least codes for beamforming based on Grassmannian predictive coding (GPC) in a MIMO system. In an embodiment, a computer program may comprise: codes for estimating present channel direction information (CDI) according to a received signal; codes for predicting future CDI based on the present CDI and at least one of previous CDIs; codes for predicting future codebook based on present codebook and at least one of previous codebooks; codes for selecting a codeword from the future codebook based on the future CSI; and codes for feeding back an index of the selected codeword to the transmitter.

Based on the above description, the skilled in the art would appreciate that the present invention may be embodied in an apparatus, a method, or a computer program product. Thus, the present invention may be specifically implemented in the following manners, i.e., complete hardware, complete software (including firmware, resident software, microcode, etc), or a combination of software part and hardware part as generally called “circuit,” “module,” or “system” herein. Further, the present invention may also adopt a form of computer program product as embodied in any tangible medium of expression, the medium comprising computer-usable program code.

Any combination of one or more computer-usable or computer-readable mediums may be used. The computer-usable or computer-readable medium may be for example, but not limited to, electrical, magnetic, optical, electromagnetic, infrared, or semiconductor system, means, device, or propagation medium. More specific examples (non-exhaustive list) of the computer-readable medium comprise: an electric connection having one or more leads, a portable computer magnetic disk, hard disk, random access memory (RAM), read-only memory (ROM), erasable programmable read-only memory (EPROM or flash), optical fiber, portable compact disk read-only memory (CD-ROM), optical storage device, a transmission medium for example, supporting internet or intranet, or a magnetic storage device. It should be noted that the computer-usable or computer readable medium may even be a paper printed with a program thereon or other suitable medium, because the program may be obtained electronically by electrically scanning such paper or other medium, and then compiled, interpreted or processed in a suitable manner, and if necessary, stored in a computer memory. In the context of the present document, a computer-usable or computer-readable medium may be any medium containing, storing, communicating, propagating, or transmitting a program available for an instruction execution system, apparatus or device, or associated with the instruction execution system, apparatus, or device. A computer-usable medium may comprise a data signal contained in a base band or propagated as a part of carrier and embodying a computer-usable program code. A computer-usable program code may be transmitted by any suitable medium, including, but not limited to, radio, wire, cable, or RF, etc.

A computer program code for executing operations of the present invention may be written by any combination of one or more program design languages, the program design languages including object-oriented program design languages, such as Java, Smalltalk, C++, etc, as well as conventional procedural program design languages, such as “C” program design language or similar program design language. A program code may be completely or partly executed on a user computer, or executed as an independent software package, partly executed on the user computer and partly executed on a remote computer, or completely executed on a remote computer or server. In the latter circumstance, the remote computer may be connected to the user computer through various kinds of networks, including local area network (LAN) or wide area network (WAN), or connected to external computer (for example, by means of an internet service provider via Internet).

Further, each block in the flow charts and/or block diagrams of the present invention and combination of respective blocks therein may be implemented by computer program instructions. These computer program instructions may be provided to a processor of a general purpose computer, a dedicated computer or other programmable data processing apparatus, thereby generating a machine such that these instructions executed through the computer or other programmable data processing apparatus generate means for implementing functions/operations prescribed in the blocks of the flow charts and/or block diagrams.

These computer program instructions may also be stored in a computer-readable medium capable of instructing the computer or other programmable data processing apparatus to work in a particular manner, such that the instructions stored in the computer-readable medium generate a product including instruction means for implementing the functions/operations prescribed in the flow charts and/or block diagrams.

The computer program instructions may also be loaded on a computer or other programmable data processing apparatus, such that a series of operation steps are implemented on the computer or other programmable data processing apparatus, to generate a computer-implemented process, such that execution of the instructions on the computer or other programmable apparatus provides a process of implementing the functions/operations prescribed in the blocks of the flow charts and/or block diagrams.

Though the exemplary embodiments of the present invention are described herein with reference to the drawings, it should be understood that the present invention is not limited to these accurate embodiments, and a person of normal skill in the art can make various modifications to the embodiments without departing from the scope and principle of the present invention. All such variations and modifications are intended to be included in the scope of the present invention as defined in the appended claims.

1. A method for beamforming based on Grassmannian predictive coding (GPC) in a MIMO system, comprising:
estimating present channel direction information (CDI) according to a received signal;
predicting future CDI based on the present CDI and at least one of previous CDIs;
predicting future codebook based on present codebook and at least one of previous codebooks;
selecting a codeword from the future codebook based on the future CSI; and
feeding back an index of the selected codeword to the transmitter.

2. The method of claim 1, wherein estimating CDI according to a received signal comprises:
obtaining a channel matrix according to a received signal;
calculating the singular value decomposition (SVD) of the channel matrix; and
obtaining present CDI based on the SVD of the channel matrix.

3. The method of claim 1, wherein predicting future CDI based on the present CDI and at least one of previous CDIs comprises:
calculating an error metric between the present CDI and the previous CDI; and
obtaining the future CDI along the geodestic direction based on the present CDI, the previous CDI, a step size and the error metric.

4. The method of claim 3, wherein the step size is optimized by:
defining a set of step sizes;
calculating the error metric between the future CDI and the average of previous CDIs by using each of the set of step sizes; and
determining a step size corresponding to the minimum error metric.

5. The method of claim 1, wherein predicting future codebook based on present codebook and at least one of previous codebooks comprises:
calculating an error metric between the present codebook and the previous codebook; and
obtaining the future codebook along the geodestic direction based on the present codebook, the previous CDI, a step size and the error metric.

6. The method of claim 5, wherein the step size is optimized by:
defining a set of step sizes;
calculating the error metric between the future codebook and the average of previous codebooks by using each of the set of step sizes; and
determining a step size corresponding to the minimum error metric.

7. The method of claim 1, wherein selecting a codeword from the future codebook based on the future CDI comprises:
calculating an error metric between each codeword in the future codebook and the future CDI; and
determining a codeword which corresponds to the minimum error metric as the selected codeword.

8. The method of claim 3, wherein the error metric is one of the chordal distance, the Fubini-Study distance, the projection-two norm, and the Euclidean metric.

9. A method for beamforming based on Grassmannian predictive coding (GPC) in a MIMO system, comprising:
receiving an index of a selected codeword from a receiver;
predicting future codebook based on present codebook and at least one of previous codebooks;
selecting a codeword from the future codebook based on the index; and
performing beamforming by using the selected codeword.

10. The method of claim 9, wherein predicting future codebook based on present codebook and at least one of previous codebooks comprises:
calculating an error metric between the present codebook and the previous codebook; and
obtaining the future codebook along the geodestic direction based on the present codebook, the previous CDI, a step size and the error metric.

11. The method of claim 10, wherein the step size is optimized by:
defining a set of step sizes;
calculating the error metric between the future codebook and the average of previous codebooks by using each of the set of step sizes; and
determining a step size corresponding to the minimum error metric.

12. An receiver for beamforming based on Grassmannian predictive coding (GPC) in a MIMO system, comprising:
an estimating device, configured to estimate present channel direction information (CDI) according to a received signal;
a CDI predicting device, configured to predict future CDI based on the present CDI and at least one of previous CDIs;
a codebook predicting device, configured to predict future codebook based on present codebook and at least one of previous codebooks;
a selecting device, configured to select a codeword from the future codebook based on the future CSI; and
a feedback device, configured to feed back an index of the selected codeword to the transmitter.

13. The receiver of claim 12, wherein the estimating device comprises:
means for obtaining a channel matrix according to a received signal;
means for calculating the singular value decomposition (SVD) of the channel matrix; and
means for obtaining present CDI based on the SVD of the channel matrix.

14. The receiver of claim 12, wherein the CDI predicting device comprises:
means for calculating an error metric between the present CDI and the previous CDI; and
means for obtaining the future CDI along the geodestic direction based on the present CDI, the previous CDI, a step size and the error metric.

15. The receiver of claim 14, wherein the CDI predicting device further comprises:
means for defining a set of step sizes;
means for calculating the error metric between the future CDI and the average of previous CDIs by using each of the set of step sizes; and
means for determining a step size corresponding to the minimum error metric.

16. The receiver of claim 12, wherein the codebook predicting device comprises:
means for calculating an error metric between the present codebook and the previous codebook; and
means for obtaining the future codebook along the geodestic direction based on the present codebook, the previous CDI, a step size and the error metric.

17. The receiver of claim 16, wherein the codebook predicting device further comprises:
means for defining a set of step sizes;
means for calculating the error metric between the future codebook and the average of previous codebooks by using each of the set of step sizes; and
means for determining a step size corresponding to the minimum error metric.

18. The receiver of claim 12, wherein the selecting device comprises:
means for calculating an error metric between each codeword in the future codebook and the future CDI; and
means for determining a codeword which corresponds to the minimum error metric as the selected codeword.

19. The receiver of claim 14, wherein the error metric is one of the chordal distance, the Fubini-Study distance, the projection-two norm, and the Euclidean metric.

20. A transmitter for beamforming based on Grassmannian predictive coding (GPC) in a MIMO system, comprising:
a receiving device, configured to receive an index of a selected codeword from a receiver;
a predicting device, configured to predict future codebook based on present codebook and at least one of previous codebooks;
a selecting device, configured to select a codeword from the future codebook based on the index; and
a beamforming device, configured to perform beamforming by using the selected codeword.

21. The transmitter of claim 20, wherein the predicting device comprises:
means for calculating an error metric between the present codebook and the previous codebook; and
means for obtaining the future codebook along the geodestic direction based on the present codebook, the previous CDI, a step size and the error metric.

22. The transmitter of claim 21, wherein the predicting device further comprises:
means for defining a set of step sizes;
means for calculating the error metric between the future codebook and the average of previous codebooks by using each of the set of step sizes; and
means for determining a step size corresponding to the minimum error metric.
